(19) United States
(12) Patent Application Publication
(10) Pub. No.: US 2011/0125981 A1
(43) Pub. Date: May 26, 2011

(54) CONTENT PROCESSING APPARATUS

(75) Inventor: Takahiro MIOMO, Higashiosaka-shi (JP)

(73) Assignee: SANYO ELECTRIC CO., LTD., Osaka (JP)

(21) Appl. No.: 12/954,535

(22) Filed: Nov. 24, 2010

(30) Foreign Application Priority Data
Nov. 25, 2009 (JP) 2009-266964

(51) Int. Cl. G06F 12/00

(52) U.S. Cl. 711/173; 711/E12.001

(57) ABSTRACT

A content processing apparatus includes a taker. A taker takes a plurality of partial contents in an internal memory. A first transferor transfers the plurality of partial contents taken by the taker to an external memory by each partial amount. A creator repeatedly creates link information representing a link state of transfer-destination addresses by the first transferor in the internal memory, in parallel with a transfer process of the first transferor. An updater updates the link information created by the creator so that the plurality of partial contents transferred by the first transferor are combined with each other. A second transferor transfers the link information updated by the updater to the external memory.

### CROSS REFERENCE OF RELATED APPLICATION

The disclosure of Japanese Patent Application No. 2009-266964, which was filed on Nov. 25, 2009, is incorporated herein by reference.

### BACKGROUND OF THE INVENTION

1. Field of the Invention

The present invention relates to a content processing apparatus. More particularly, the present invention relates to a content processing apparatus which is applied to a digital video camera and stores a plurality of partial contents in a combined state in an external memory.

2. Description of the Related Art

According to one example of this type of apparatus, when an interval photographing or an animation photographing is selected, a photographing process is executed at an intermittent timing.

Image data generated by every photographing process is accommodated in a temporary area of a recording medium. Upon completion of the photographing process executed for designated number of times, a plurality of frames of image data accommodated in the temporary area are converted into a moving-image file, and a converted moving-image file is accommodated into a normal recording area of the recording medium.

However, when the moving-image file is created, the image data is transferred bidirectionally between the recording medium and an internal memory. Such a bidirectional transfer causes a time period required for a creation of the moving-image file being protracted.

### SUMMARY OF THE INVENTION

A content processing apparatus according to the present invention, comprises: a taker which takes a plurality of partial contents in an internal memory; a first transferor which transfers the plurality of partial contents taken by the taker to an external memory by each partial amount; a creator which repeatedly creates link information representing a link state of transfer-destination addresses by the first transferor in the internal memory, in parallel with a transfer process of the first transferor; an updater which updates the link information created by the creator so that the plurality of partial contents transferred by the first transferor are combined with each other; and a second transferor which transfers the link information updated by the updater to the external memory.

A content processing program product according to the present invention is a content processing program product executed by a processor of a content processing apparatus, comprises: a taking step which takes a plurality of partial contents in an internal memory; a first transferring step which transfers the plurality of partial contents taken by the taking step to an external memory by each partial amount; a creating step which repeatedly creates link information representing a link state of transfer-destination addresses by the first transferring step in the internal memory, in parallel with the transfer process of the first transferring step; an updating step which updates the link information created by the creating step so that the plurality of partial contents transferred by the first transferring step are combined with each other; and a second transferring step which transfers the link information updated by the updating step to the external memory.

A content processing method according to the present invention is a content processing method executed by a content processing apparatus, comprises: a taking step which takes a plurality of partial contents in an internal memory; a first transferring step which transfers the plurality of partial contents taken by the taking step to an external memory by each partial amount; a creating step which repeatedly creates link information representing a link state of transfer-destination addresses by the first transferring step in the internal memory, in parallel with the transfer process of the first transferring step; an updating step which updates the link information created by the creating step so that the plurality of partial contents transferred by the first transferring step are combined with each other; and a second transferring step which transfers the link information updated by the updating step to the external memory.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of a mapping state of an SDRAM applied to the embodiment in FIG. 2;

FIG. 4 is an illustrative view showing one example of a mapping state of a memory card applied to the embodiment in FIG. 2;

FIG. 5 is an illustrative view showing one example of a plurality of temporary files created by the embodiment in FIG. 2;

FIG. 6 is an illustrative view showing one example of a structure of the temporary file which contains H264 data and AAC data;

FIG. 7 is an illustrative view showing one example of a structure of a combined file created by the embodiment in FIG. 2;

FIG. 8 is a flowchart showing one portion of behavior of a CPU applied to the embodiment in FIG. 2;

FIG. 9 is a flowchart showing another portion of behavior of the CPU applied to the embodiment in FIG. 2;

FIG. 10 is a flowchart showing still another portion of behavior of the CPU applied to the embodiment in FIG. 2;

FIG. 11 is a flowchart showing yet another portion of behavior of the CPU applied to the embodiment in FIG. 2;

FIG. 12 is a flowchart showing another portion of behavior of the CPU applied to the embodiment in FIG. 2;

FIG. 13 is a flowchart showing still another portion of behavior of the CPU applied to the embodiment in FIG. 2;

FIG. 14 is a flowchart showing yet another portion of behavior of the CPU applied to the embodiment in FIG. 2;

FIG. 15 is a flowchart showing another portion of behavior of the CPU applied to the embodiment in FIG. 2; and

FIG. 16 is a flowchart showing yet another portion of behavior of the CPU applied to the embodiment in FIG. 2.

### DETAILED DESCRIPTION OF THE PREFERRED EMBODIMENTS

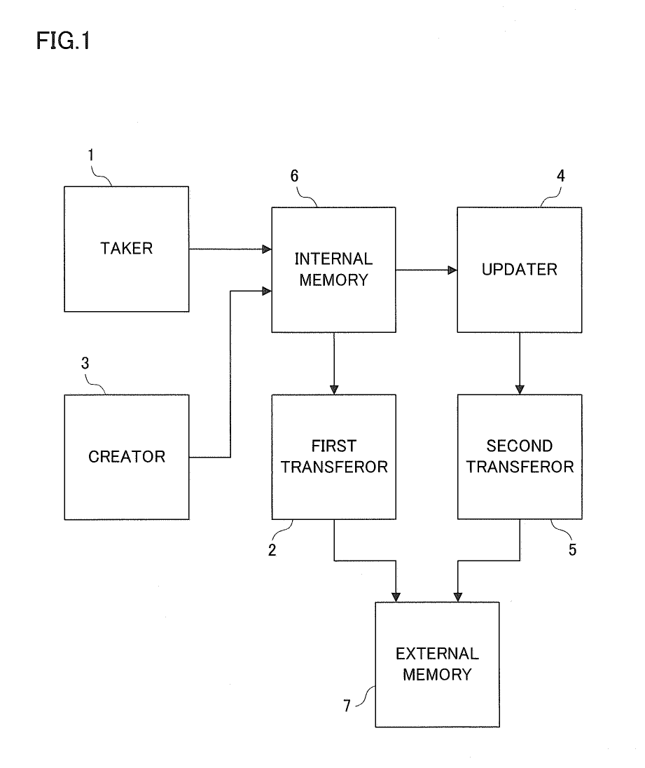

With reference to FIG. 1, a content processing apparatus of one embodiment of the present invention is basically configured as follows: A taker 1 takes a plurality of partial contents in an internal memory 6. A first transferor 2 transfers the plurality of partial contents taken by the taker 1 to an external memory 7 by each partial amount. A creator 3 repeatedly creates link information representing a link state of transfer-destination addresses by the first transferor 2 in the internal memory 6, in parallel with a transfer process of the first transferor 2. An updater 4 updates the link information created by the creator 3 so that the plurality of partial contents transferred by the first transferor 2 are combined with each other. A second transferor 5 transfers the link information updated by the updater 4 to the external memory 7.

The plurality of partial contents accommodated in the internal memory 6 are transferred to the external memory 7 by each partial amount. On the other hand, the link information created on the internal memory 6 in parallel with the transfer process for the partial amount is updated on the internal memory 6 so that the plurality of partial contents are combined with each other, and is transferred to the external memory 7 thereafter. Therefore, transfer directions of both the partial contents and the link information are limited to one-way of the internal memory 6 to the external memory 7. Thereby, a time period required for the process is shortened.

It is noted that the term “take” used in a clause of the taker 1 may be replaced by the term “fetch” or “acquire”. In this case, the plurality of contents are fetched or acquired by a fetcher or an acquirer.

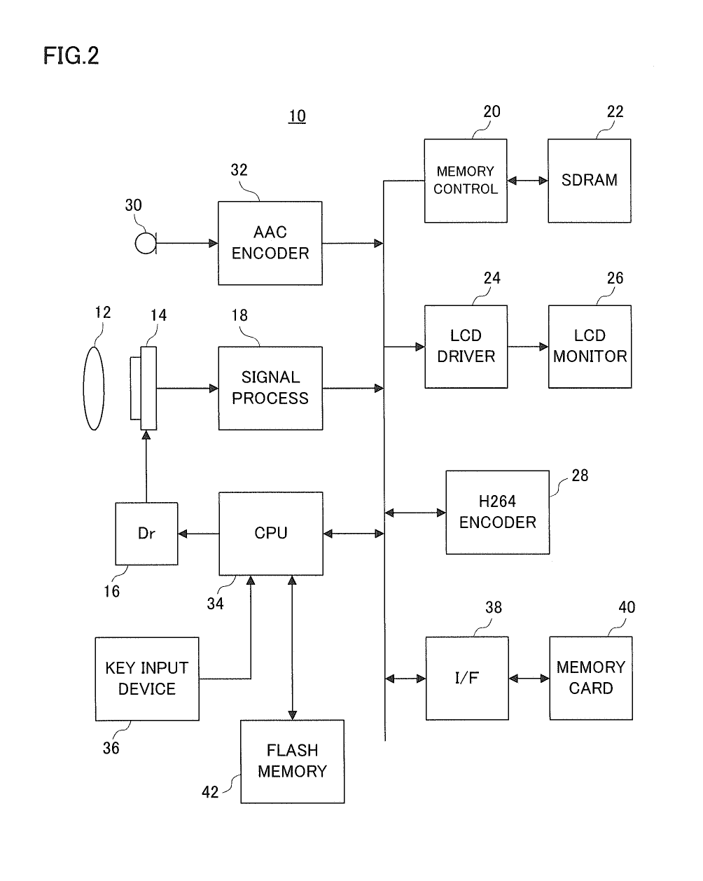

With reference to FIG. 2, a digital video camera 10 according to this embodiment includes an optical lens 12. An optical image of a scene enters, with irradiation, an imaging surface of an imager 14 via the optical lens 12 and is subjected to a photoelectric conversion.

When a power source is applied, an imaging task of a CPU 34 commands a driver 16 to repeat an exposure procedure and an electric-charge reading-out procedure in order to execute a moving-image taking process. In response to a vertical synchronization signal Vsync generated at every 1/30th of a second, the driver 16 exposes the imaging surface of the imager 14 and reads out the electric charges produced on the imaging surface in a raster scanning manner. From the imager 14, raw image data based on the read-out electric charges is outputted periodically.

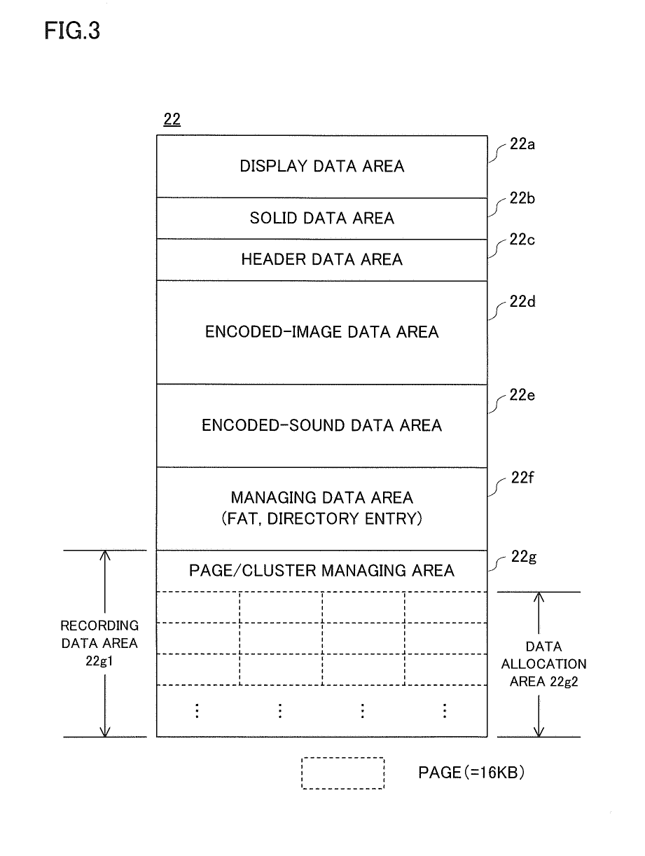

A signal-processing circuit 18 performs processes, such as white balance adjustment, color separation, and YUV conversion, on the raw image data outputted from the imager 14, and writes image data of a YUV format generated thereby into a display data area 22a of an SDRAM 22 (see FIG. 3) through a memory control circuit 20. An LCD driver 24 repeatedly reads out the image data accommodated in the display data area 22a through the memory control circuit 20, and drives an LCD monitor 26 based on the read-out image data. As a result, a through image representing the scene is displayed on a monitor screen.

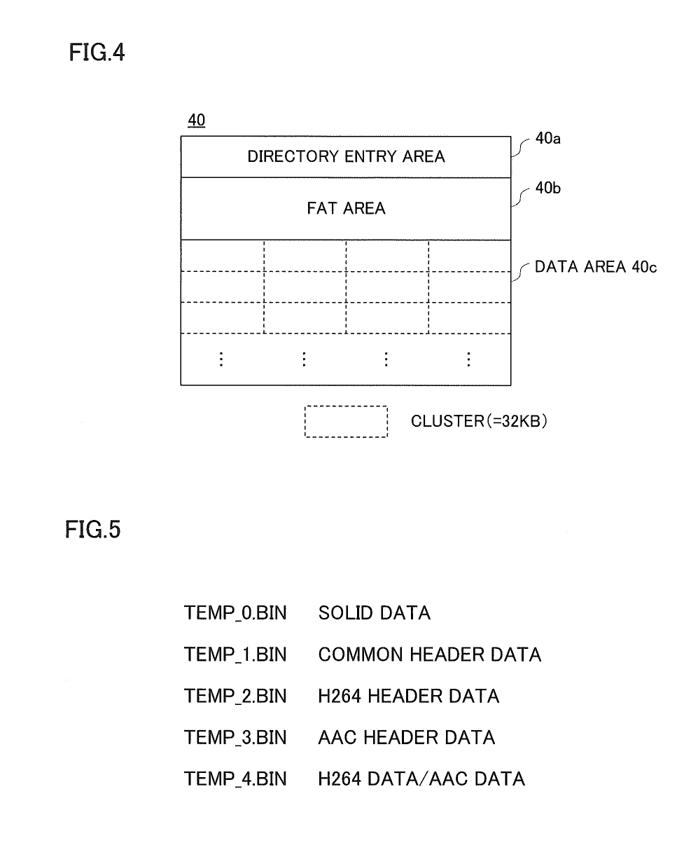

With reference to FIG. 4, a memory card 40 adopts an FAT file system and has a directory entry area 40a which holds a directory entry and an FAT area 40b which holds an FAT along with a data area 40c which holds an image file.

The data area 40c is formed by a plurality of clusters each of which has a capacity of 32 Kbytes, for example. The directory entry manages file attributes, such as a file name, a file size, a cluster number of a head cluster which records a file, and recording time and date, for each image file recorded on the data area 40c. Moreover, the FAT has a plurality of columns respectively corresponding to the plurality of clusters which form the data area, and manages a link state of one or at least two clusters which hold data of common image-file.

In response to the power source being applied, a recording control task of the CPU 34 reads out the directory entry and the FAT stored in the memory card 40 through an I/F 38, and writes the read-out directory entry and FAT into a managing data area 22f of the SDRAM 22 (see FIG. 3) through the memory control circuit 20.

When a recoding start operation is performed on a key input device 36 in a state where the through image is displayed on the LCD monitor 26, the imaging task issues a file-creation instruction toward the recording control task.

The recording control task describes a head cluster and a file size (=0) of a temporary file “TEMP_N. BIN” in the directory entry on the managing data area 22f, and allocates a file ID indicating “N” to the temporary file “TEMP_N. BIN”. Thereby, creating and opening the temporary file “TEMP_N. BIN” are completed. A variable N is incremented from “0” to “4”, and an above-described process is executed corresponding to each of variables “0” to “4”. As a result, temporary files “TEMP_{—}0. BIN” to “TEMP_{—}4. BIN” that are in an opened state are obtained.

When the temporary files “TEMP_{—}0. BIN” to “TEMP_{—}4. BIN” are obtained, the recording control task issues a file-creation completion notification toward the imaging task. The imaging task starts up an H264 encoder 28 and an AAC encoder 32 in response to the file-creation completion notification.

The H264 encoder 28 reads out the image data accommodated in the display data area 22a of the SDRAM 22 through the memory control circuit 20, encodes the read-out image data in accordance with an H264 format, and writes the encoded data, i.e., H264 data into an encoded-image data area 22d of the SDRAM 22 (see FIG. 3) through the memory control circuit 20.

The AAC encoder 32 encodes sound data representing an external sound captured by a microphone 30 in accordance with an AAC format, and writes the encoded data, i.e., AAC data into an encoded-sound data area 22e of the SDRAM 22 (see FIG. 3) through the memory control circuit 20.

The imaging task issues a file-writing instruction which is described total size of one second of the H264 data and one second of the AAC data and a file ID indicating “4” toward the recording control task at each time one second of the H264 data and one second of the AAC data are secured in the encoded-image data area 22d and the encoded-sound data area 22e.

When a recording end operation is performed on the key input device 36, the imaging task issues a file-writing instruction which is described total size of less than one second of the H264 data and less than one second of the AAC data respectively remaining in the encoded-image data area 22d and the encoded-sound data area 22e and the file ID indicating “4” toward the recording control task.

Subsequently, the imaging task creates solid data on a solid data area 22b of the SDRAM 22 (see FIG. 3), and issues a file-writing instruction which is described a size of the solid data and a file ID indicating “0” toward the recording control task.

The imaging task also creates common header data on a header data area 22c of the SDRAM 22 (see FIG. 3), and issues a file-writing instruction which is described a size of the common header data and a file ID indicating “1” toward the recording control task.

The imaging task further creates H264 header data on the header data area 22c, and issues a file-writing instruction which is described a size of the H264 data and a file ID indicating “2” toward the recording control task.

Moreover, the imaging task creates AAC header data on the header data area 22c, and issues a file-writing instruction which is described a size of the AAC header data and a file ID indicating “3” toward the recording control task.

The recording control task specifies a temporary file corresponding to the file ID described in the file-writing instruction from among the temporary files “TEMP_{—}0. BIN” to “TEMP_{—}4. BIN”.

The temporary file “TEMP_{—}0. BIN” is specified when the file ID indicates “0”, and the temporary file “TEMP_{—}1. BIN” is specified when the file ID indicates “1”. Moreover, the temporary file “TEMP_{—}2. BIN” is specified when the file ID indicates “2”, the temporary file “TEMP_{—}3. BIN” is specified when the file ID indicates “3”, and the temporary file “TEMP_{—}4. BIN” is specified when the file ID indicates “4”.

With reference to the FAT accommodated in the managing data area 22f, the recording control task also specifies partial vacant clusters equivalent to a size described in the file-writing instruction out of the plurality of clusters which form the data area 40c in the memory card 40 as recording-destination clusters. Since a capacity of one cluster is 32 Kbytes, when the size described in the file-writing instruction is 120 Kbytes, four vacant clusters are specified as the recording-destination clusters.

With reference to FIG. 3, the SDRAM 22 further has a recording data area 22g. The recording data area 22g is divided into a page/cluster managing area 22g1 and a data allocation area 22g2. Moreover, the data allocation area 22g2 is formed by a plurality of pages each of which has a capacity of 16 Kbytes. The page/cluster managing area 22g1 will be described later.

Subsequently, the recording control task divides the size described in the file-writing instruction by a page size (=16 Kbytes) so as to calculate number of pages required for writing data equivalent to the size described in the file-writing instruction. The calculated number of pages is set to a variable PGN. When the size described in the file-writing instruction is 120 Kbytes, eight pages are required for writing data, and therefore, the variable PNG is set to “8”.

In a case where there are enough vacant pages in the data allocation area 22g2, the recording control task designates any one of the vacant pages as a moving-destination page, and moves one page of data out of the data according to the file-writing instruction to the moving-destination page.

Therefore, when the file ID indicates “0”, at least one part of the solid data accommodated in the solid data area 22b is moved to the moving-destination page. When the file ID indicates “1”, at least one part of the common header data accommodated in the header data area 22c is moved to the moving-destination page. When the file ID indicates “2”, at least one part of the H264 header data accommodated in the header data area 22c is moved to the moving-destination page.

Likewise, when the file ID indicates “3”, at least one part of the AAC header data accommodated in the header data area 22c is moved to the moving-destination page. When the file ID indicates “4”, at least one part of one second of the H264 data accommodated in the encoded-image data area 22d and/or one second of the AAC data accommodated in the encoded-sound data area 22e is moved to the moving-destination page.

Such processes are repeated for the number of times equivalent to the variable PGN, and as a result, all the data according to the file-writing instruction is moved to the data allocation area 22g2. Upon completion of moving whole data, the recording control task creates page/cluster correlation information indicating a correspondence relationship between the recording-destination cluster and the moving-destination page, and writes the created page/cluster correlation information in the page/cluster managing area 22g1.

Thus created page/cluster correlation information is referred by the recording control task when the data on the data allocation area 22g2 is stored in the memory card 40, in other words, when the vacant page is formed in the data allocation area 22g2. Firstly, the recording control task specifies a page which holds the oldest data from the data allocation area 22g2. Subsequently, the recording control task specifies a cluster corresponding to the page holding the oldest data with reference to the page/cluster correlation information, and transfers the oldest data to the specified cluster. As a result of the transfer process, the vacant page is formed in the data allocation area 22g2.

Thereafter, the recording control task updates the FAT on the managing data area 22f so that a link is formed between clusters holding data corresponding to a common file ID. The recording control task also updates a description (a file size, specifically) of the directory entry on the managing data area 22f, corresponding to the update of the FAT. It is noted that these update processes are executed at each time the file-writing instruction is issued.

As a result, as shown in FIG. 5, the data according to the file-writing instruction which is described the file ID indicating “0”, i.e., the solid data is contained in the temporary file “TEMP_{—}0. BIN”, and the data according to the file-writing instruction which is described the file ID indicating “1”, i.e., the common header data is contained in the temporary file “TEMP_{—}1. BIN”.

Moreover, the data according to the file-writing instruction which is described the file ID indicating “2”, i.e., the H264 header data is contained in the temporary file “TEMP_{—}2. BIN”, and the data according to the file-writing instruction which is described the file ID indicating “3”, i.e., the AAC header data is contained in the temporary file “TEMP_{—}3. BIN”.

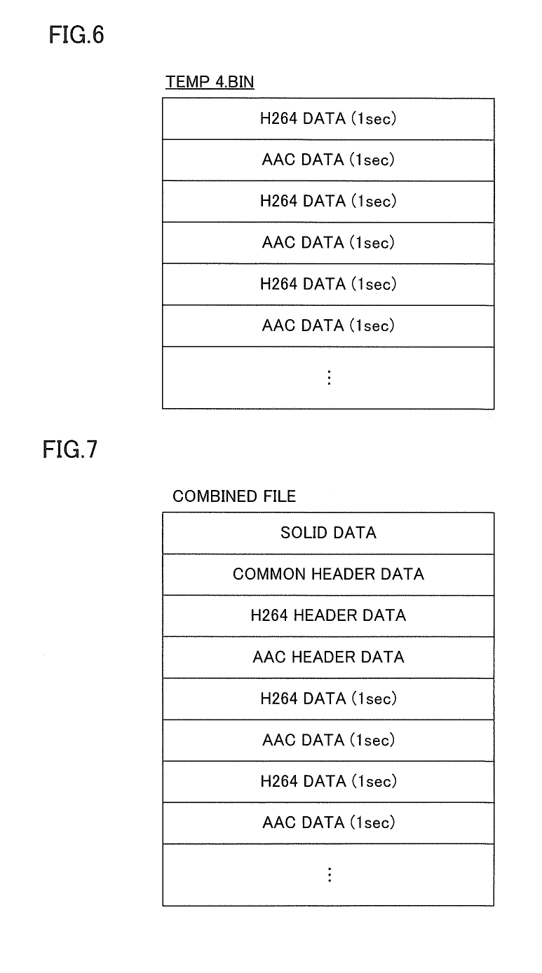

Furthermore, the data according to the file-writing instruction which is described the file ID indicating “4”, i.e., the H264 data and the AAC data are contained in the temporary file “TEMP_{—}4. BIN”. Since the file-writing instruction which is described the file ID indicating “4” is issued at each time one second of the H264 data and one second of the AAC data are secured, the H264 data and the AAC data are contained in the temporary file “TEMP_{—}1. BIN” in a manner shown in FIG. 6.

After issuing the file-writing instruction noticing the AAC header data, the imaging task issues a file-connection instruction toward the recording control task. The recording control task updates the FAT on the managing data area 22f so that the head cluster of the temporary file “TEMP_N. BIN” is combined to an end cluster of the temporary file “TEMP_{—}0. BIN”.

Subsequently, the recording control task updates the description (the file size, specifically) of the directory entry on the managing data area 22f, corresponding to the temporary file “TEMP_{—}0. BIN”. The file size increases as much as the size of the temporary file “TEMP_N. BIN”. Furthermore, the recording control task deletes the description of the temporary file “TEMP_N. BIN” from the directory entry on the managing data area 22f, and abolishes the file ID of the temporary file “TEMP_N. BIN”.

The variable N is incremented from “1” to “4”, and the above-described process is executed corresponding to each of “1” to “4”. As a result, the temporary files “TEMP_{—}1. BIN” to “TEMP_{—}4. BIN” are combined to the temporary file “TEMP_{—}0. BIN”, and a combined file shown in FIG. 7 is obtained.

Thereafter, the recording control task transfers remaining data in the data allocation area 22g2 to the memory card 40 with reference to the page/cluster correlation information. Upon completion of transferring whole data, the recording control task transfers the FAT corresponding to the temporary file “TEMP_{—}0. BIN” to the FAT area 40b in the memory card 40, and further transfers the directory entry corresponding to the temporary file “TEMP_{—}0. BIN” to the directory entry area 40a in the memory card 40. Thereby, a part of the FAT and directory entry stored in the memory card 40 is updated by the transferred FAT and directory entry.

Thereafter, the recording control task abolishes the file ID of the temporary file “TEMP_{—}0. BIN”, and changes the file name of the temporary file “TEMP_{—}0. BIN” described in the directory entry to a normal file name. Thus, the image file having the normal file name is stored in the memory card 40.

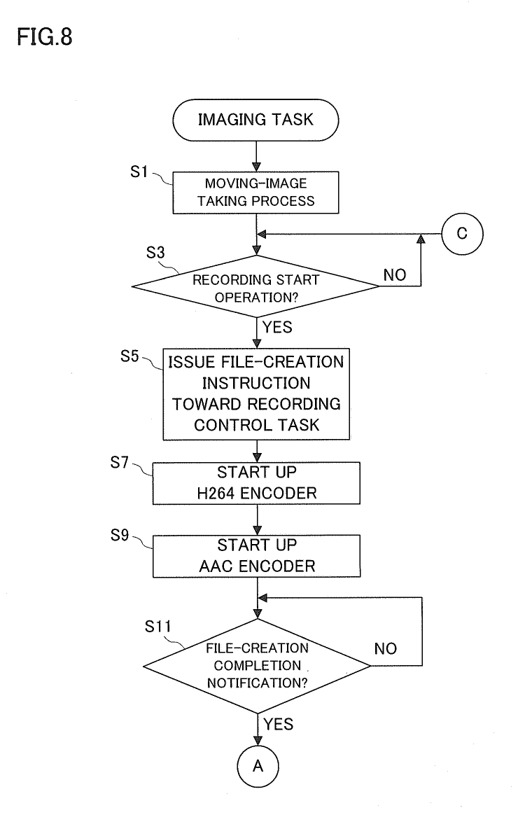

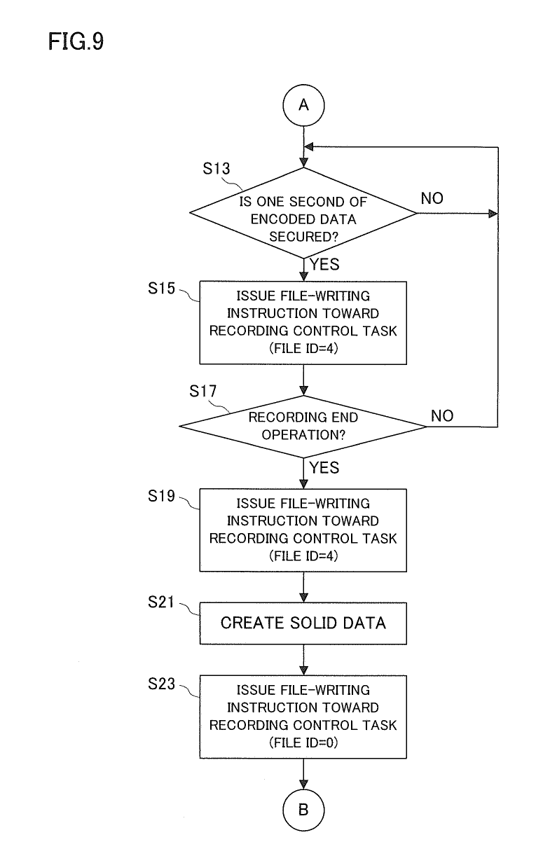

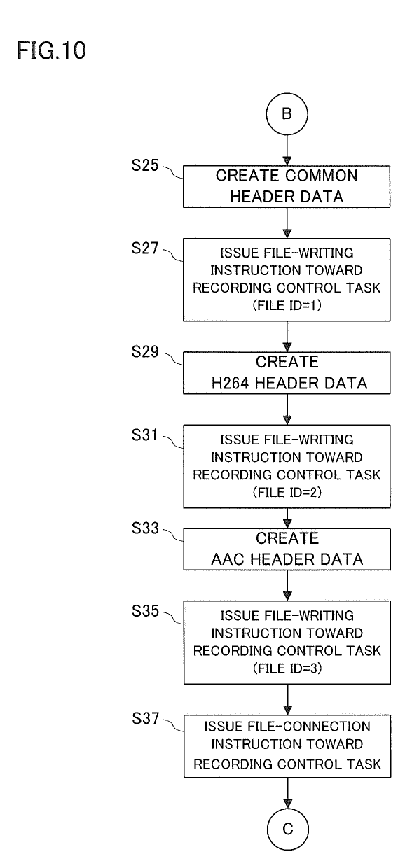

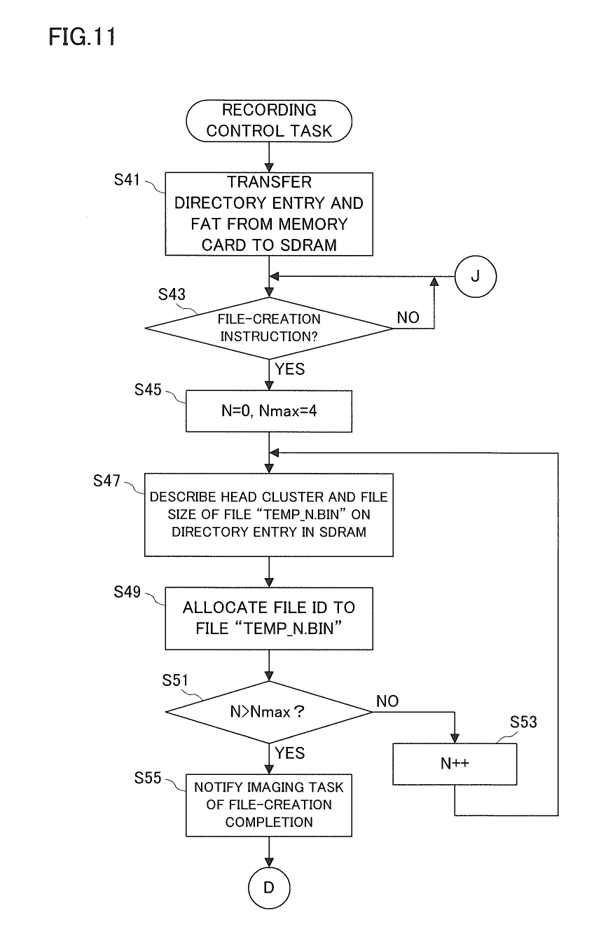

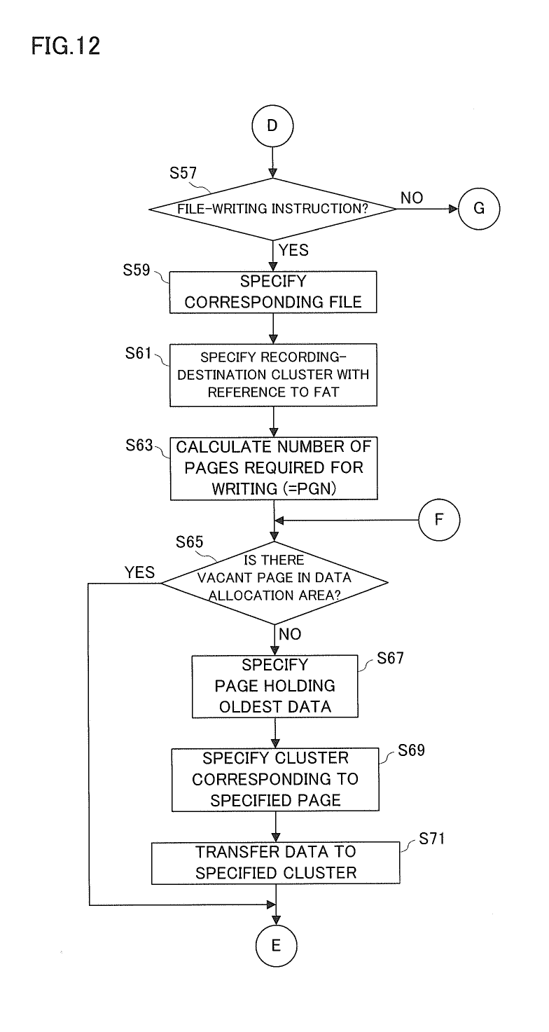

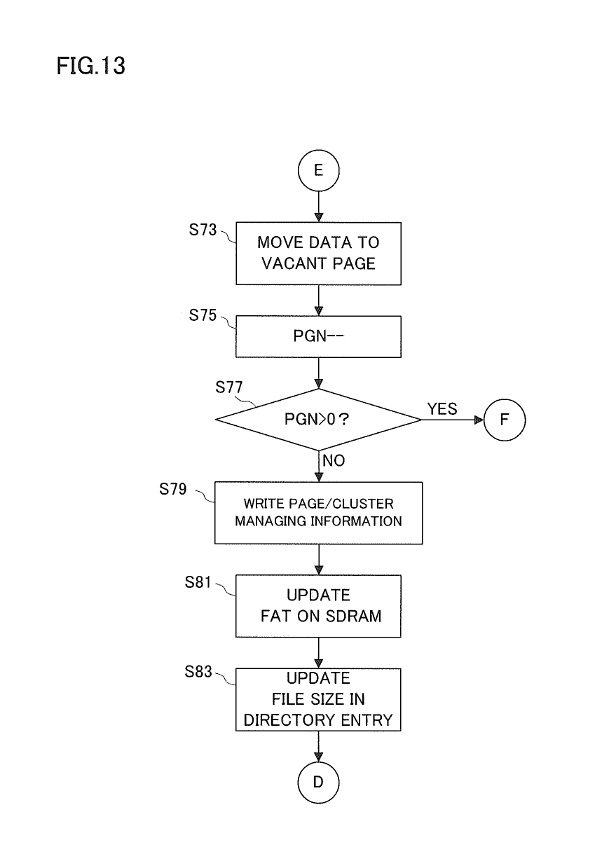

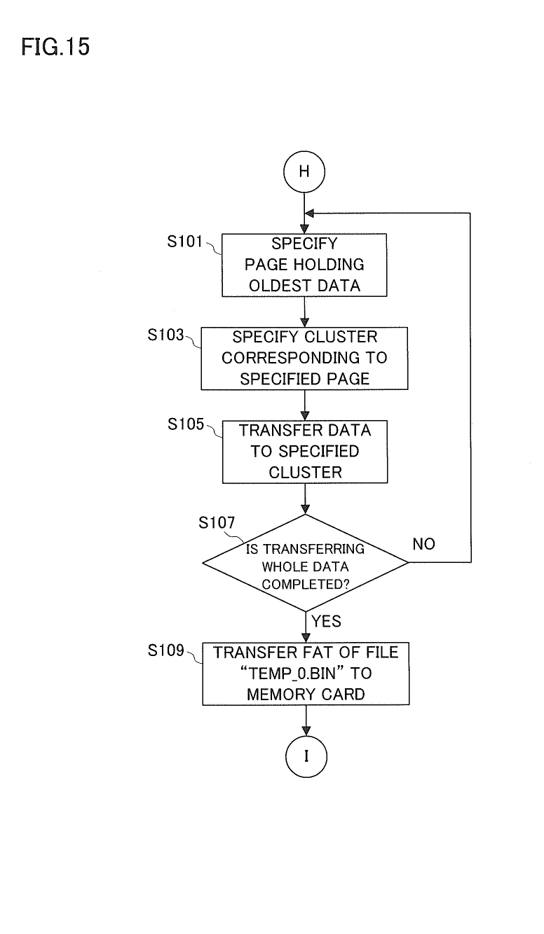

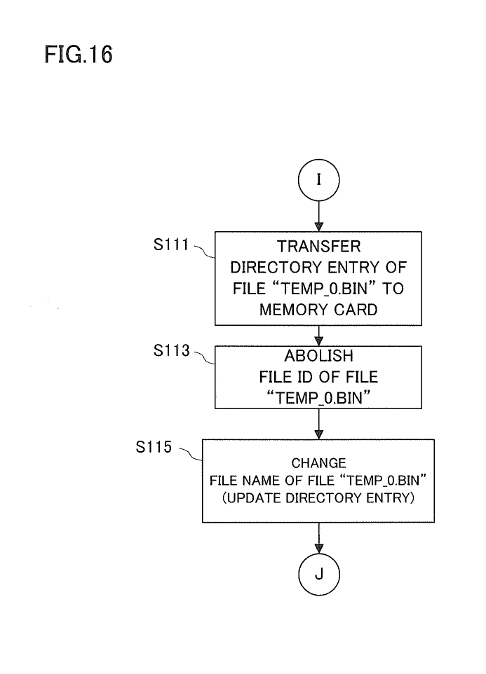

The imaging task is specifically configured as shown in FIG. 8 to FIG. 10, and the recording control task is specifically configured as shown in FIG. 11 to FIG. 16. It is noted that a control program corresponding to these tasks are memorized in a flash memory 42.

With reference to FIG. 8, firstly in a step S1, the moving-image taking process is executed. As a result, a moving image representing the scene is displayed on the LCD monitor 26. In a subsequent step S3, it is determined whether or not a recording start operation is performed. When the determined result is updated from NO to YES, the process advances to a step S5 so as to issue the file-creation instruction toward the recording control task. As a result, the temporary files “TEMP_{—}0. BIN” to “TEMP_{—}4. BIN” are newly created. In a step S7, the H264 encoder 28 is started up, and in a step S9, the AAC encoder 32 is started up.

The H264 encoder 28 reads out the image data accommodated in the display data area 22a of the SDRAM 22 through the memory control circuit 20, encodes the read-out image data to the H264 data, and writes the encoded H264 data into the encoded-image data area 22d of the SDRAM 22 through the memory control circuit 20.

The AAC encoder 32 encodes the sound data representing the external sound captured by the microphone 30 to the AAC data, and writes the encoded AAC data into the encoded-sound data area 22e of the SDRAM 22 through the memory control circuit 20.

In a step S11, it is determined whether or not the file-creation completion notification is applied from the recording control task. When the determined result is updated from NO to YES, the process advances from the step S11 to a step S13 so as to determine whether or not one second of the H264 data and one second of the AAC data are secured in the encoded-image data area 22d and the encoded-sound data area 22e. When the determined result is updated from NO to YES, the process advances to a step S15 so as to issue toward the recording control task the file-writing instruction which is described the total size of one second of the H264 data and one second of the AAC data and the file ID indicating “4”.

As a result, one second of the H264 data is moved from the encoded-image data area 22d to the data allocation area 22g2, and one second of the AAC data is moved from the encoded-sound data area 22e to the data allocation area 22g2. The moved H264 data and AAC data are thereafter contained in the temporary file “TEMP_{—}4. BIN”.

In a step S17, it is determined whether or not the recording end operation is performed, and when the determined result is NO, the process returns to the step S13 while when the determined result is YES, the process advances to a step S19. Therefore, the process in the step S15 is executed every one second as long as the recording end operation is not performed, and one second of the H264 data and one second of the AAC data are alternately moved to the recording data area 22g.

In the step S19, the file-writing instruction which is described the total size of less than one second of the H264 data and less than one second of the AAC data respectively remaining in the encoded-image data area 22d and the encoded-sound data area 22e and the file ID indicating “4” is issued toward the recording control task. As a result, the corresponding H264 data and AAC data are moved to the data allocation area 22g2, and thereafter contained in the temporary file “TEMP_{—}4. BIN”.

In a step S21, the solid data is created on the solid data area 22b, and in a step S23, the file-writing instruction which is described the size of the solid data and the file ID indicating “0” is issued toward the recording control task. As a result, the solid data on the solid data area 22b is moved to the data allocation area 22g2, and thereafter contained in the temporary file “TEMP_{—}0. BIN”.

In a step S25, the common header data is created on the header data area 22c, and in a step S27, the file-writing instruction which is described the size of the common header data and the file ID indicating “1” is issued toward the recording control task. As a result, the common header data on the header data area 22c is moved to the data allocation area 22g2, and thereafter contained in the temporary file “TEMP_{—}1. BIN”.

In a step S29, the H264 header data is created on the header data area 22c, and in a step S31, the file-writing instruction which is described the size of the H264 data and the file ID indicating “2” is issued toward the recording control task. As a result, the H264 header data on the header data area 22c is moved to the data allocation area 22g2, and thereafter contained in the temporary file “TEMP_{—}2. BIN”.

In a step S33, the AAC header data is created on the header data area 22c, and in a step S35, the file-writing instruction which is described the size of the AAC header data and the file ID indicating “3” is issued toward the recording control task. As a result, the AAC header data on the header data area 22c is moved to the data allocation area 22g2, and thereafter contained in the temporary file “TEMP_{—}3. BIN”.

When the temporary files “TEMP_{—}0. BIN” to “TEMP_{—}4. BIN” are completed, the process advances to a step S37, and the file-connection instruction is issued toward the recording control task. As a result, the temporary files “TEMP_{—}0. BIN” to “TEMP_{—}4. BIN” are combined with each other, and the combined file is completed. Upon the completion of the process in the step S37, the process returns to the step S3.

With reference to FIG. 11, in a step S41, the directory entry and the FAT stored in the memory card 40 are transferred to the managing data area 22f of the SDRAM 22. In a step S43, it is determined whether or not the file-creation instruction is issued. When the determined result is updated from NO to YES, the process advances to a step S45. Then, the variable N is set to “0”, and concurrently, a variable Nmax is set to “4”.

In the step S47, the head cluster and the file size (=0) of the temporary file “TEMP_N. BIN” are described in the directory entry on the managing data area 22f and in a step S49, the file ID indicating “N” is allocated to the temporary file “TEMP_N. BIN”. Thereby, creating and opening the temporary file “TEMP_N. BIN” are completed.

In a step S51, it is determined whether or not the variable N exceeds the variable Nmax, and when the determined result is NO, the variable N is incremented in a step S53, and thereafter, the process returns to the step S47. As a result, temporary files “TEMP_{—}0. BIN” to “TEMP_{—}4. BIN” that are in the opened state are obtained.

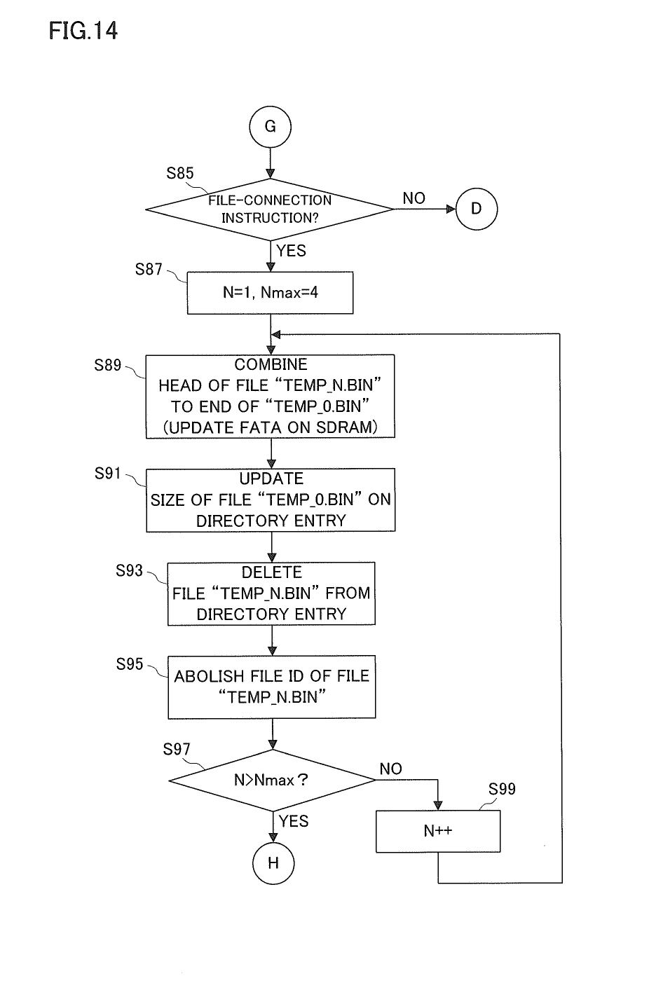

When the determined result in the step S51 is YES, the process advances to a step S55, and the file-creation completion notification is issued toward the imaging task. As a result, the determined result in the step S11 shown in FIG. 8 is updated from NO to YES. Upon completion of the process in the step S55, it is determined in a step S57 whether or not the file-writing instruction is applied from the imaging task, and it is determined in a step S85 (see FIG. 14) whether or not the file-connection instruction is applied from the imaging task.

When YES is determined in the step S57, the process advances to a step S59 so as to specify the temporary file corresponding to the file ID described in the file-writing instruction from among the temporary files “TEMP_{—}0. BIN” to “TEMP_{—}4. BIN”. In a step S61, with reference to the FAT accommodated in the managing data area 22f, the partial vacant clusters equivalent to the size described in the file-writing instruction is specified from the data area 40c in the memory card 40. The specified vacant clusters are defined as the recording-destination cluster.

In a step S63, the size described in the file-writing instruction is divided by the page size (=16 Kbytes) so as to calculate the number of pages required for writing data equivalent to the size described in the file-writing instruction. The calculated number of pages is set to the variable PGN.

In a step S65, it is determined whether or not there are vacant pages in the data allocation area 22g2, and when the determined result is YES, the process directly advances to a step S73 while when the determined result is NO, the process advances to the step S73 via steps S67 to S71.

In the step S67, the page which holds the oldest data is specified from among a plurality of pages on the data allocation area 22g2. In the step S69, with reference to the page/cluster correlation information described in the page/cluster managing area 22g1, a cluster corresponding to the page specified in the step S67 is specified from among the plurality of clusters which form the data area 40c in the memory card 40. In the step S71, data of the page specified in the step S67 is transferred to the cluster specified in the step S69. Thereby, one page of data is recorded in the memory card 40, and a vacant page is formed in the data allocation area 22g2.

In the step S73, a vacant page existing in the data allocation area 22g2 from the beginning or the vacant page formed by the transfer process in the step S71 is designated as the moving-destination page, and one page of data out of the data according to the file-writing instruction is written in the moving-destination page.

Therefore, when the file ID indicates “0”, at least one part of the solid data accommodated in the solid data area 22b is moved to the moving-destination page. When the file ID indicates “1”, at least one part of the common header data accommodated in the header data area 22c is moved to the moving-destination page. When the file ID indicates “2”, at least one part of the H264 header data accommodated in the header data area 22c is moved to the moving-destination page.

Likewise, when the file ID indicates “3”, at least one part of the AAC header data accommodated in the header data area 22c is moved to the moving-destination page. When the file ID indicates “4”, at least one part of one second of the H264 data accommodated in the encoded-image data area 22d and/or one second of the AAC data accommodated in the encoded-sound data area 22e is moved to the moving-destination page.

Upon completion of the process in the step S73, the variable PGN is decremented in a step S75. In a step S77, it is determined whether or not the variable PGN is exceeds “0”, and when the determined result is YES, the process returns to the step S65. As a result, all the data according to the file-writing instruction are moved to the data allocation area 22g2.

When the determined result in the step S77 is YES, the process advances to a step S79, and the page/cluster correlation information indicating the corresponding relationship between the recording-destination cluster specified in the step S61 and the moving-destination page designated in the step S73 is written in the page/cluster managing area 22g1. The written page/cluster correlation information is referred to in the above-described step S69.

In a step S81, the FAT on the managing data area 22f is updated so that the cluster specified in the step S61 is linked to another cluster which holds the data of the temporary file specified in the step S59. In a step S83, the description (the file size, specifically) of the directory entry on the managing data area 22f is updated corresponding to the temporary file specified in the step S59. Upon completion of the process in the step S83, the process returns to the step S57.

When YES is determined in the step S85 shown in FIG. 14, the process advances to a step S87. Then, the variable N is set to “1”, and concurrently, the variable Nmax is set to “4”. In a step S89, the FAT on the managing data area 22f is updated so that the cluster equivalent to the head of the temporary file “TEMP_N. BIN” is combined to the cluster equivalent to the end of the temporary file “TEMP_{—}0. BIN”. In a step S91, the description (the file size, specifically) of the directory entry on the managing data area 22f is updated corresponding to the temporary file “TEMP_{—}0. BIN”. The file size is increased as much as the size of the temporary file “TEMP_N. BIN”.

In a step S93, the description of the temporary file “TEMP_N. BIN” is deleted from the directory entry on the managing data area 22f, and in a step S95, the file ID of the temporary file “TEMP_N. BIN” is abolished. In a step S97, it is determined whether or not the variable N exceeds the variable Nmax, and when the determined result is NO, the variable N is incremented in the step S93, and thereafter, the process returns to the step S89. As a result, the temporary files “TEMP_{—}1. BIN” to “TEMP_{—}4. BIN” are combined to the temporary file “TEMP_{—}0. BIN”.

When YES is determined in the step S97, processes similar to that in the above-described steps S67 to S71 are executed in steps S101 to S105. In a step S107, it is determined whether or not all the data on the data allocation area 22g2 are transferred to the memory card 40, and as long as the determined result is NO, processes in the steps S101 to S105 are repeated. As a result, the data remaining in the data allocation area 22g2 is recorded in the memory card 40.

When YES is determined in the step S107, the FAT corresponding to the temporary file “TEMP_{—}0. BIN” is transferred in a step S109 to the memory card 40, and the directory entry corresponding to the temporary file “TEMP_{—}0. BIN” is transferred in a step S111 to the memory card 40. Thereby, a part of the FAT and directory entry stored in the memory card 40 is updated by the transferred FAT and directory entry.

In a step S113, the file ID of the temporary file “TEMP_{—}0. BIN” is abolished. In a step S115, the file name of the temporary file “TEMP_{—}0. BIN” described in the directory entry is changed to the normal file name. Upon completion of the process in the step S115, the process returns to the step S43.

As can be seen from the above-described explanation, the CPU 34 takes, fetches or acquires the solid data, the common header data, the H264 header data, the AAC header data, and the H264/AAC data in the SDRAM 22 (S61, S73, S79), and transfers these taken data by each 16 Kbytes to the memory card 40 (S67 to S71, S101 to S105). Moreover, the CPU 34 repeatedly creates the FAT representing a link state of transfer-destination clusters in the SDRAM 22 (S59, S81) in parallel with the transfer process, and updates the created FAT so that the transferred data are combined with each other (S89). Upon completion of the updating process, the CPU 34 transfers the FAT to the memory card 40 (S109).

The data accommodated in the SDRAM 22 is transferred to the memory card 40 by each 16 Kbytes. On the other hand, the FAT created in the SDRAM 22 in parallel with the transfer process by each 16 Kbytes is updated on the SDRAM 22 so that the transferred data are combined with each other, and thereafter transferred to the memory card 40. Thus, transfer directions of both the data and the FAT are limited to one-way of the SDRAM 22 to the memory card 40. Thereby, a time period required for the process is shortened.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A content processing apparatus, comprising:
a taker which takes a plurality of partial contents in an internal memory;
a first transferor which transfers the plurality of partial contents taken by said taker to an external memory by each partial amount;
a creator which repeatedly creates link information representing a link state of transfer-destination addresses by said first transferor in said internal memory, in parallel with a transfer process of said first transferor;
an updater which updates the link information created by said creator so that the plurality of partial contents transferred by said first transferor are combined with each other; and
a second transferor which transfers the link information updated by said updater to said external memory.

2. A content processing apparatus according to claim 1, wherein said external memory has a data area divided into a plurality of unit areas each of which has a predetermined size, and the partial amount is equivalent to 1/N (N: integer) of the predetermined size.

3. A content processing apparatus according to claim 1, wherein said creator individually creates the link information corresponding to each of the plurality of partial contents, and said updater updates the link information so that the plurality of the partial contents continue in a predetermined order.

4. A content processing apparatus according to claim 1, further comprising:
an allocator which respectively allocates a plurality of partial file names to the plurality of partial contents, in association with a taking process of said taker; and
a deleter which deletes one or at least two partial file names other than a reference partial file name out of the plurality of partial file names allocated by said allocator, in parallel with an updating process of said updater.

5. A content processing apparatus according to claim 4, further comprising a changer which changes the reference partial file name to a normal file name after the updating process of said updater is completed.

6. A content processing apparatus according to claim 1, wherein a part of the plurality of partial contents is equivalent to image data and/or sound data, and another part of the plurality of partial contents is equivalent to head data.

7. A content processing program product executed by a processor of a content processing apparatus, comprising:
a taking step which takes a plurality of partial contents in an internal memory;
a first transferring step which transfers the plurality of partial contents taken by said taking step to an external memory by each partial amount;
a creating step which repeatedly creates link information representing a link state of transfer-destination addresses by said first transferring step in said internal memory, in parallel with a transfer process of said first transferring step;
an updating step which updates the link information created by said creating step so that the plurality of partial contents transferred by said first transferring step are combined with each other; and
a second transferring step which transfers the link information updated by said updating step to said external memory.

8. A content processing method executed by a content processing apparatus, comprising:
a taking step which takes a plurality of partial contents in an internal memory;
a first transferring step which transfers the plurality of partial contents taken by said taking step to an external memory by each partial amount;
a creating step which repeatedly creates link information representing a link state of transfer-destination addresses by said first transferring step in said internal memory, in parallel with a transfer process of said first transferring step;
an updating step which updates the link information created by said creating step so that the plurality of partial contents transferred by said first transferring step are combined with each other; and
a second transferring step which transfers the link information updated by said updating step to said external memory.
